(19) United States
(12) Patent Application Publication
(10) Pub. No.: US 2007/0104917 A1
(43) Pub. Date: May 10, 2007

(54) Packaging with a break line and method for manufacturing the same

(76) Inventors: Michael Krug, Jena (DE); Norbert Preuss, Jena (DE); Werner Wollmann, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/501,960

(22) Filed: Aug. 10, 2006

(30) Foreign Application Priority Data
Aug. 12, 2005 (DE) 10 2005 038 642.3

(51) Int. Cl. G09F 3/00

(52) U.S. Cl. 428/43

(57) ABSTRACT

The invention is directed to packaging comprising a multiple-layer material construction with a break line which is formed by a line-shaped, successive arrangement of blind holes separated by webs and in which the multiple-layer material construction comprises at least one layer which absorbs laser radiation and a layer which reflects this laser radiation. A radiation-absorbing layer forms the surface layer of the packaging, and the blind holes of the surface layer extend into the packaging until the reflecting layer, and the web widths are substantially constant over the depths of the blind holes so that there are abrupt jumps in material thickness along the break line, and a clearly audible noise is generated when these jumps in material thickness are overcome when the break line tears. The invention is further directed to a method for producing packaging of this kind.

### CROSS-REFERENCE TO RELATED APPLICATION

This application claims priority of German Application No. 10 2005 038 642.2, filed Aug. 12, 2005, the complete disclosure of which is hereby incorporated by reference.

### BACKGROUND OF THE INVENTION

a) Field of the Invention

The invention is directed to packaging with a break line which comprises blind holes arranged successively at a distance from one another and to a method for generating a break line of this kind in packaging. Packaging according to the invention is particularly suitable when a clearly audible noise should be generated.

b) Description of the Related Art

Many packagings having a break line are known from the prior art, including those comprising blind holes or recesses which are arranged successively at a distance from one another. In order to package objects in an airtight manner in particular, the blind holes or recesses do not completely penetrate the packaging material. The necessary tearing force can be varied by means of the spacing between the blind holes (web width).

Packaging for foodstuffs in particular generally comprises multiple layers of material in order to satisfy all of the functional requirements for packaging, e.g., rigidity, tear resistance, tightness against water vapor and air, through the various layers. Layers of plastic, metal or paper are used for this purpose.

The paper layer or pasteboard or cardboard layer generally forms the outermost layer, if one disregards the layers on top (e.g., paint layer, lacquer layer or plastic layer) whose purpose is visual, and is followed by a metal layer, generally of aluminum, which is embedded between diverse plastic layers.

A mechanical process known as paring is suitable for introducing blind holes in the prefabricated multiple-layer material construction. The circumferential area of holes of this kind is determined by the shape of the paring knife and its forward feed. In cross section along the cutting direction, the shape of the hole corresponds to a circle segment, i.e., the web widths between the individual holes increase as the depth increases.

It is also known to introduce blind holes in a prefabricated multiple-layer material construction by means of a laser. In order to generate actual blind holes instead of continuous holes, the laser parameters such as wavelength, power and pulse regime are selected taking into account the different materials with different absorption behavior. From among the materials which each carry out a specific function, those materials which are absorbent for the cutting laser are deliberately selected for the individual layers.

A CO₂ laser in particular is used as a cutting laser. Paper and many plastics are highly absorbent for its emission wavelength of 10.6 μm.

The shape of a laser-produced blind hole, whose depth is determined by the energy introduced, basically resembles a parabola or the profile of a Gaussian bell curve. In this case also, the web widths always increase as the depth increases.

Both of the above-described techniques for introducing blind holes in a prefabricated multiple-layer material construction of packaging generate a break line through removal of material, which produces little noise when this packaging is deliberately torn along the break line.

### OBJECT AND SUMMARY OF THE INVENTION

It is the primary object of the invention to provide packaging comprising a multiple-layer material construction and a break line for tearing the packaging which generates a distinctly audible noise when tearing.

Another object is to provide a method for producing packaging according to the invention.

These objects are met by packaging in accordance with the invention, comprising a multiple-layer material construction with a break line which is formed by a line-shaped, successive arrangement of blind holes separated by webs, wherein the multiple-layer material construction comprises at least one layer which absorbs a laser radiation and a layer which reflects this laser radiation. A radiation-absorbing layer is included which forms the surface layer of the packaging. The surface layer has blind holes which extend into the packaging until the reflecting layer. Web widths are substantially constant over the depths of the blind holes so that there are abrupt jumps in material thickness along the break line. A clearly audible noise is generated when these jumps in material thickness are overcome when the break line tears.

The objects are also met in accordance with the invention by a method for generating a break line in multiple-layer packaging material, which break line causes a noise comprising the steps of providing at least one layer which absorbs a laser radiation and a layer (reflection layer) which reflects this laser radiation, wherein a radiation-absorbing layer forms the surface layer of the packaging, and guiding a laser beam along the provided break line relative to the surface of the packaging so that a line-shaped, successive arrangement of blind holes separated by webs is formed. The laser beam is permitted to continue to act after impinging on the reflection layer until the base of the blind hole has undergone an expansion which at least approximates the expansion of the blind hole in the surface layer so that the increase in the web width is reduced along the depth of the blind holes.

The solution according to the invention makes it possible to provide packaging which meets all of the long-standing requirements for packaging such as tightness against air and moisture, stiffness or flexibility, and tear resistance, has a surface which is visually attractive to customers, and also generates a distinctly audible noise when the break line provided for opening is torn.

It is essential for the method according to the invention that the depth of the blind holes which are generated by means of lasers are not determined solely by the laser parameters and material parameters of the material layers to be penetrated; rather, the depth is determined by the impingement on an embedded material layer (reflection layer) which reflects the laser radiation, and the laser is not turned off when the laser beam first impinges on the reflection layer, but rather continues to act until the base of the hole has undergone an appreciable expansion close to or equal to the expansion of the blind hole at the outer surface of the packaging.

It is essential for the packaging according to the invention that the increase in the web widths between the blind holes is reduced over the depth of the blind hole so that there is an appreciable jump in material thickness at the transitions between the blind holes and the webs. The larger and more abrupt this jump in material thickness, the more audible the noise which is generated when the break line is torn and, therefore, when the jumps in material thickness are overcome. Accordingly, in order to generate the loudest possible noise, the reflection layer should be embedded in the layer construction as far as possible from the outer surface of the packaging. Material layers having a high material strength should be arranged, if possible, before the reflection layer with reference to the outer surface of the packaging so that the difference between the tear resistance of the webs and the tear resistance of the material thickness (residual wall) remaining below the base of the blind hole is as large as possible. The tear resistance along the break line can be influenced only by means of the hole spacing and, therefore, by the web widths since the depth of the blind hole is predetermined.

The invention will be described more fully in the following with reference to embodiment examples.

### BRIEF DESCRIPTION OF THE DRAWING

In the drawing:

FIG. 1 shows a schematic sectional view through packaging according to the invention.

### DESCRIPTION OF THE PREFERRED EMBODIMENTS

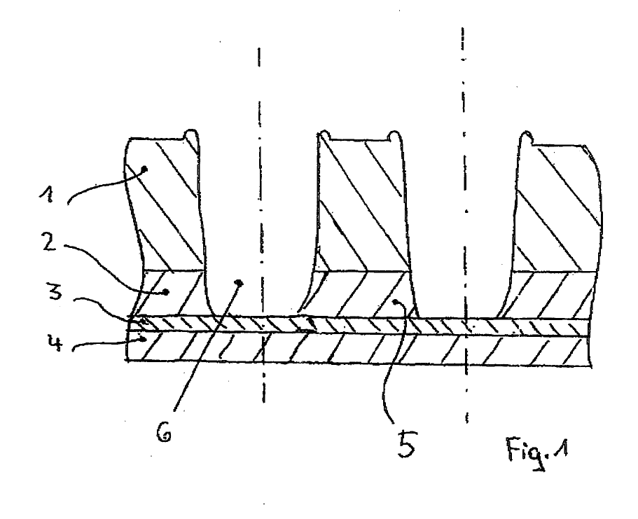

FIG. 1 shows the multiple-layer construction of packaging comprising four layers in which a series of blind holes which are separated by webs 5 has been introduced by laser. The blind holes 6 extend through a surface layer 1 comprising, e.g., polypropylene (PP) and a second layer 2 comprising, e.g., a polyethylene layer (PE) until the surface of a reflection layer 3 comprising, e.g., aluminum. The reflection layer 3 is followed by a fourth layer 4 comprising, e.g., PE.

In general, all of the layers, or all of the layers with the exception of the reflection layer 3, have a determined function which must be performed by the multiple-layer construction for the packaging. The functions and accordingly also the specific materials performing a corresponding function are not relevant to the invention.

The materials must only be sufficiently absorbent for the same laser radiation insofar as the respective material layer is arranged before the reflection layer 3 with respect to the outer surface of the packaging. In this example, that would be the surface layer 1 and the second layer 2. The reflection layer 3 is highly reflecting for this laser radiation.

In contrast to known laser ablation methods in which the ablating depth is determined solely by the energy input, that is, is carried out without hindrance, the ablating depth is defined by the position of the reflection layer 3 inside the multiple-layer construction. However, the laser radiation does not cease to act as soon as it impinges on the reflection layer 3, but rather continues for a predetermined amount of time. The shape of the blind holes 6 changes in this way. In particular, a radially expanding removal of material is carried out in the second layer 2, on the reflection layer 3, at the base of the blind holes 6. The surfaces which are exposed in this way on the reflection layer 3 are larger as the energy input increases. As soon as the expansion of these free surfaces corresponds to the expansion of the blind holes 6 at the surface of the packaging or almost reaches this expansion, no further energy is introduced through the action of laser radiation.

The blind holes can be generated by a laser that is not regulated because fluctuations in the ablation volume have only a negligible effect on the consistency of the tearing force that is generally required for a break line of this kind due to the fixed ablating depth. When the laser is not regulated, the optimal process parameters for an optimal blind hole 6 are determined through trials.

However, it is advantageous to regulate the laser, i.e., to detect the impingement of the laser radiation on the reflection layer 3 by a sensor and limit the subsequent further input of energy into the respective blind hole by means of the laser output or to limit the radiation period or pulse number in such a way that an optimal blind hole 6 is formed. By means of this regulation, fluctuations in parameters until the laser radiation impinges on the reflection layer will have no effect on the blind hole 6 that is formed.

The process parameters are optimized in such a way that the increase in the width of the webs occurring up to the impingement of the laser beam on the reflection layer 3 is reduced so that the width of the webs is as constant as possible over the depth of the blind hole.

For optimizing the process, it is also advantageous to ensure that a bead of melted material occurs around the rim of the blind hole.

While the foregoing description and drawings represent the present invention, it will be obvious to those skilled in the art that various changes may be made therein without departing from the true spirit and scope of the present invention.

### REFERENCE NUMBERS

1 surface layer
2 second layer
3 reflection layer
4 fourth layer
5 webs
6 blind holes

What is claimed is:

1-7. (canceled)

8. Packaging comprising a multiple-layer material construction with a break line which is formed by a line-shaped, successive arrangement of blind holes separated by webs, wherein the multiple-layer material construction comprises:
at least one layer which absorbs a laser radiation and a layer which reflects this laser radiation, wherein a radiation-absorbing layer forms the surface layer of the packaging;
said surface layer having blind holes which extend into the packaging until the reflecting layer;
web widths being substantially constant over the depths of the blind holes so that there are abrupt jumps in material thickness along the break line; and
a clearly audible noise being generated when these jumps in material thickness are overcome when the break line tears.

9. Packaging according to claim 8, wherein the material layers with high tear strength are arranged before the reflection layer with respect to the surface layer.

10. Packaging according to claim 8, wherein all of the material layers which, as per their function, must not be arranged after the reflection layer with respect to the surface of the packaging are arranged before the reflection layer.

11. Packaging according to claim 8, wherein the tear strength of the webs is as high as possible in relation to the tear strength of the break line, and the tear strength of the material (residual wall) remaining below the bases of the blind holes in relation to the tear strength of the break line is as small as possible in order to achieve a maximum difference in tear strength between the webs and the residual walls so as to increase the loudness of the noise.

12. Packaging according to claim 8, wherein the blind holes are generated by laser so that a bead of melted material occurs around the rim of the blind holes, which contributes to increasing the tear strength of the webs.

13. A method for generating a break line in multiple-layer packaging material, which break line causes a noise, comprising the steps of:
providing at least one layer which absorbs a laser radiation and a layer (reflection layer) which reflects this laser radiation, wherein a radiation-absorbing layer forms the surface layer of the packaging; and
guiding a laser beam along the provided break line relative to the surface of the packaging so that a line-shaped, successive arrangement of blind holes separated by webs is formed; and
permitting the laser beam to continue to act after impinging on the reflection layer until the base of the blind hole has undergone an expansion which at least approximates the expansion of the blind hole in the surface layer so that the increase in the web width is reduced along the depth of the blind holes.

14. The method according to claim 13, wherein the laser beam acts in a regulated manner after impinging on the reflection layer.
